(19) United States
(12) Patent Application Publication
(10) Pub. No.: US 2002/0090176 A1
(43) Pub. Date: Jul. 11, 2002

(54) Fiber optic shield

(76) Inventors: David C. Smeltz, Tannersville, PA (US); Tracy R. Kuhns, Wilmington, DE (US)

Correspondence Address: Gerald Levy, Esq., PITNEY, HARDIN, KIPP & SZUCH LLP, 711 Third Avenue, New York, NY, 10017-4059, US

(21) Appl. No.: 09/758,727

(22) Filed: Jan. 11, 2001

(51) Int. Cl. G02B 6/36

(52) U.S. Cl. 385/53

(57) ABSTRACT

The shield for fiber optic connector is formed from conductive sheet metal and shields the fiber optic connector from electromagnetic interference, particularly in the microwave range. A plurality of walls forms a passageway for insertion of the fiber optic connector therethrough. Tabs are formed on a first end of the plurality of walls and contact the face plate of the fiber optic connector. Fingers are formed on a second end of the plurality of walls and contact a conductive surface on the male fiber optic connector.

### BACKGROUND OF THE INVENTION

1. Field of the Invention

This invention pertains to a shield for a fiber optic cable connector, particularly for electromagnetic interference in the microwave frequency range.

2. Description of the Prior Art

The optical signal passing through fiber optic cable connectors can be degraded by electromagnetic interference (EMI), particularly in the microwave frequency range.

### OBJECTS AND SUMMARY OF THE INVENTION

It is therefore an object of the present invention to provide a shield from electromagnetic interference, particularly in the microwave frequency range, for fiber optic cable connectors.

It is therefore a further object of the present invention to provide a shield from EMI for fiber optic cable connectors which is inexpensive to manufacture and simple to install.

These and other objects are attained by providing a shield made from a sheet of conductive material, such as BeCu, shaped as a box with fingers on top that make contact with a conductive surface on the male connector. The fingers can either have a step on one side so that the adjacent finger located perpendicular to it can interlock or the fingers can have angles cut into both sides so that adjacent fingers can clear each other when formed. Additionally, a lip is formed on the bottom of the shield to contact the face plate of the connector.

### BRIEF DESCRIPTION OF THE DRAWINGS

Further objects and advantages of the invention will become apparent from the following description and claims, and from the accompanying drawings, wherein:

FIG. 1 is a top plan view of the fiber optic shield of the present invention.

FIG. 2 is a front plan view of the fiber optic shield of the present invention.

FIG. 3 is a side plan view of the fiber optic shield of the present invention.

FIG. 4 is a perspective view of a first aspect of the fiber optic shield of the present invention.

FIG. 5 is a perspective view of a second aspect of the fiber optic shield of the present invention.

### DETAILED DESCRIPTION OF THE PREFERRED EMBODIMENT

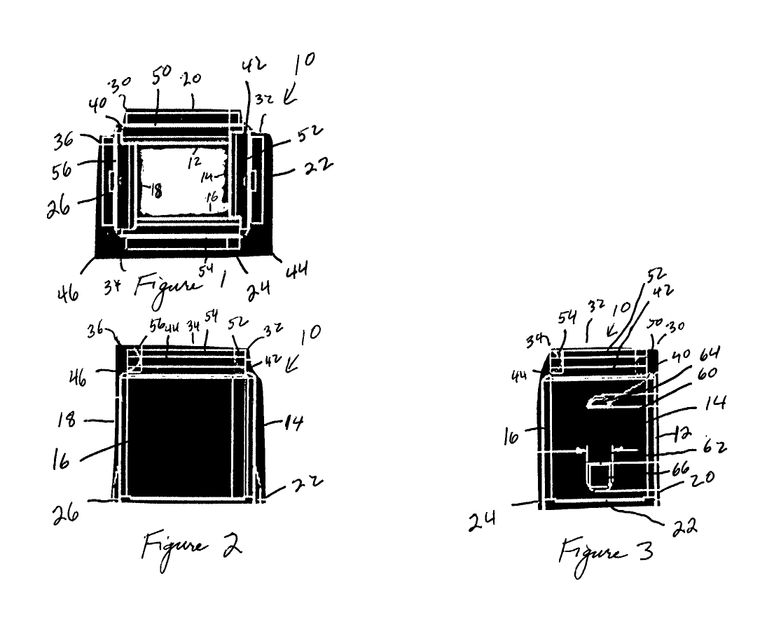

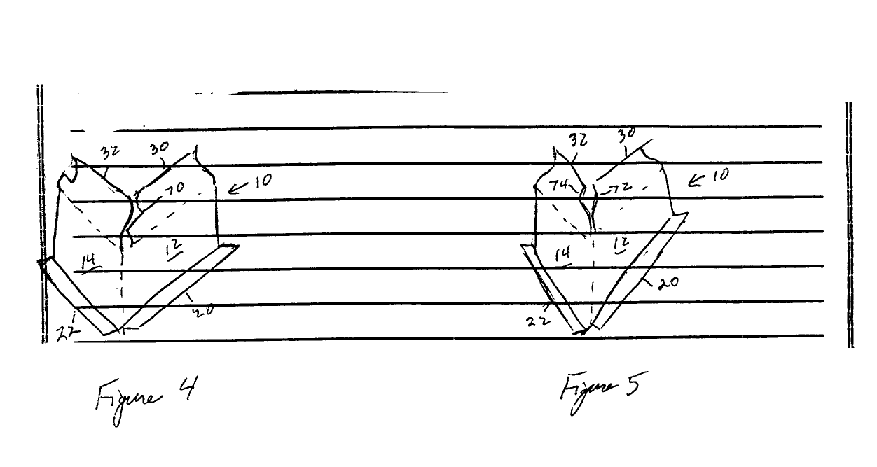

Referring now to the drawings in detail wherein like numerals indicate like elements throughout the several views, one sees that FIG. 1 is a top plan view of the fiber optic shield 10 of the present invention, while FIG. 2 is a front plan view of the fiber optic shield 10 of the present invention and FIG. 3 is a side plan view of fiber optic shield 10 of the present invention.

Fiber optic shield 10 includes sidewalls 12, 14, 16, 18 at successive right angles to each other, thereby forming a generally square or orthogonal configuration with a passageway for insertion of a fiber optic connector (not shown) therethrough. Fiber optic shield 10 is made from conductive sheet metal, such as BeCu, although those skilled in the art may realize that a range of equivalents is available. Each sidewall 12, 14, 16, 18 includes a lower tab 20, 22, 24, 26, respectively, at a right angle thereto, which make contact to the face plate of the fiber optic connector (not shown) and form a locking configuration. Each sidewall 12, 14, 16, 18 further includes an upper finger 30, 32, 34, 36 which is constructed and arranged to make physical and electrical contact with the conductive surface of a male fiber optic connector (not shown). Upper fingers 30, 32, 34, 36 include inwardly sloping surfaces 40, 42, 44, 46, respectively which extend from sidewalls 12, 14, 16, 18, respectively. Upper fingers 30, 32, 34, 36 further include outwardly sloping distal surfaces 50, 52, 54, 56 respectively which extend outwardly from inwardly sloping surfaces 40, 42, 44, 46, respectively.

As shown in FIG. 3, sidewall 14 includes slots 60, 62 into which tabs 64, 66, respectively, fit. Tabs 64, 66 extend from an internal support (not shown) which connects to sidewall 12.

As shown in FIG. 4, a pair of adjoining upper fingers (illustrated as 30 and 32) may have one finger (illustrated as 30) with a step 70 thereby allowing the pair of upper fingers to interlock. Typically, the seam between the two adjacent fingers is closed with three spot welds.

Alternately, as shown in FIG. 5, both adjoining upper fingers (illustrated as 30 and 32) may have equal angle cuts 72, 74, respectively, so that upper fingers 30, 32 clear each other when fiber optic shield 10 is formed.

To use fiber optic shield 10, the user snaps upper fingers 30, 32, 34, 36 around a male connector (not shown) so as to make contact with the conductive surfaces thereon. Additionally, lower tabs 20, 22, 24, 26 make contact with the face plate of the connector (not shown). The conductivity of the material of the fiber optic shield 10 provides for protection from electromagnetic interference (EMI).

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A shield for a fiber optic connector including:
a plurality of walls forming a passageway for insertion of the fiber optic connector therethrough, said plurality of walls having a first edge defining a first opening of said passageway and a second edge defining a second opening of said passageway;
a lip formed on said first edge for contacting a face plate of the fiber optic connector; and
fingers formed on said second edge for contacting a conductive surface on the fiber optic connector.

2. The shield of claim 1 wherein said shield is formed from sheet metal.

3. The shield of claim 2 wherein said sheet metal is BeCu.

4. The shield of claim 2 wherein said fingers are formed by a first surface sloping inwardly from said plurality of walls and a second surface sloping outwardly from said first surface.

5. The shield of claim 4 wherein said tabs are formed at right angles to said plurality of walls.

6. The shield of claim 4 wherein at each intersection of adjacent walls of said plurality of walls, a step is formed in said finger of one of said walls to allow said fingers of said adjacent walls to clear each other.

7. The shield of claim 4 wherein at each intersection of adjacent walls of said plurality of walls, angled cuts are formed in said fingers of said adjacent walls to allow said fingers of said adjacent walls to clear each other.
